(19) United States
(12) Patent Application Publication
(10) Pub. No.: US 2025/0002669 A1
(43) Pub. Date: Jan. 2, 2025

(54) DISSOLUTION APPARATUS, FOREIGN MATTER SEPARATION SYSTEM AND DISSOLUTION METHOD

(71) Applicant: Honda Motor Co., Ltd., Tokyo (JP)

(72) Inventors: Shuta Suzuki, Wako-shi (JP); Tsuyoshi Baba, Wako-shi (JP); Satoshi Hirawaki, Wako-shi (JP)

(21) Appl. No.: 18/749,614

(22) Filed: Jun. 21, 2024

(30) Foreign Application Priority Data
Jun. 27, 2023 (JP) 2023-105291

(51) Int. Cl. C08J 11/08; B01D 19/00; B01D 21/26; B01F 23/53; B01F 23/80; B01F 35/21; B01F 35/212; B01F 35/221; B01F 35/222; B01F 35/71; B01F 35/92; B01F 101/00; B29B 17/02; B29K 77/00; B29K 105/16; B29K 509/08

(52) U.S. Cl. CPC C08J 11/08; B01D 19/00; B01D 21/262; B01F 23/53; B01F 23/803; B01F 35/212; B01F 35/2136; B01F 35/2211; B01F 35/2215; B01F 35/222; B01F 35/714; B01F 35/92; B29B 17/02; B01F 2101/2805; B29B 2017/0231; B29B 2017/0293; B29K 2077/00; B29K 2105/16; B29K 2509/08; C08J 2377/02

(57) ABSTRACT

A dissolution apparatus configured to dissolve a waste resin in a dissolution tank with a solvent. The dissolution apparatus includes: a supply device configured to supply the waste resin and the solvent into the dissolution tank; a heating device configured to heat the waste resin and the solvent supplied to the dissolution tank; a stirrer configured to stir the waste resin and the solvent, heated by the heating device; a torque sensor configured to detect a load torque acting on the stirrer; and a microprocessor. The microprocessor is configured to perform: calculating a viscosity of a solution of the waste resin and the solvent based on the load torque detected by the torque sensor, and controlling at least one of the supply device and the heating device such that the viscosity calculated in the calculating becomes less than a predetermined value.

### CROSS-REFERENCE TO RELATED APPLICATION

This application is based upon and claims the benefit of priority from Japanese Patent Application No. 2023-105291 filed on Jun. 27, 2023, the content of which is incorporated herein by reference.

### BACKGROUND

### Technical Field

The present invention relates to a dissolution apparatus configured to separate foreign matters from a waste plastic, foreign matter separation system, and dissolution method.

### Related Art

As this type of technology, there is known an apparatus configured to melt waste plastic in a pyrolysis tank while stirring the waste plastic with a stirrer in a pyrolysis process in an oiling treatment of the waste plastic (see, for example, Japanese Patent No. 5132093). In the apparatus described in Japanese Patent No. 5132093, in order to prevent damage and breakage of the stirrer, start and stop timings of the rotation of the stirrer are controlled according to the load torque of the stirrer.

Incidentally, in a case of separating foreign matters from the waste plastic, it is generally necessary to stir and dissolve the waste plastic as a pre-process. In such a process, when the rotation of the stirrer is repeatedly started and stopped as in the apparatus described in Japanese Patent No. 5132093, efficient operation becomes difficult.

### SUMMARY

An aspect of the present invention is a dissolution apparatus configured to dissolve a waste resin in a dissolution tank with a solvent. The dissolution apparatus includes: a supply device configured to supply the waste resin and the solvent into the dissolution tank; a heating device configured to heat the waste resin and the solvent supplied to the dissolution tank; a stirrer configured to stir the waste resin and the solvent, heated by the heating device; a torque sensor configured to detect a load torque acting on the stirrer; and a microprocessor. The microprocessor is configured to perform: calculating a viscosity of a solution of the waste resin and the solvent based on the load torque detected by the torque sensor, and controlling at least one of the supply device and the heating device such that the viscosity calculated in the calculating becomes less than a predetermined value.

### BRIEF DESCRIPTION OF DRAWINGS

The objects, features, and advantages of the present invention will become clearer from the following description of embodiments in relation to the attached drawings, in which:

FIG. 1 is a block diagram illustrating an example of an overall configuration of the foreign matter separation system according to the embodiment of the present invention;

FIG. 2 is a diagram illustrating a configuration of main parts of the dissolution apparatus;

FIG. 3 is a diagram illustrating a configuration of main parts of the degassing apparatus;

FIG. 4 is a flowchart illustrating an example of processing executed by the controller in FIG. 2; and

FIG. 5 is a flowchart illustrating an example of processing executed by the controller in FIG. 2.

### DETAILED DESCRIPTION

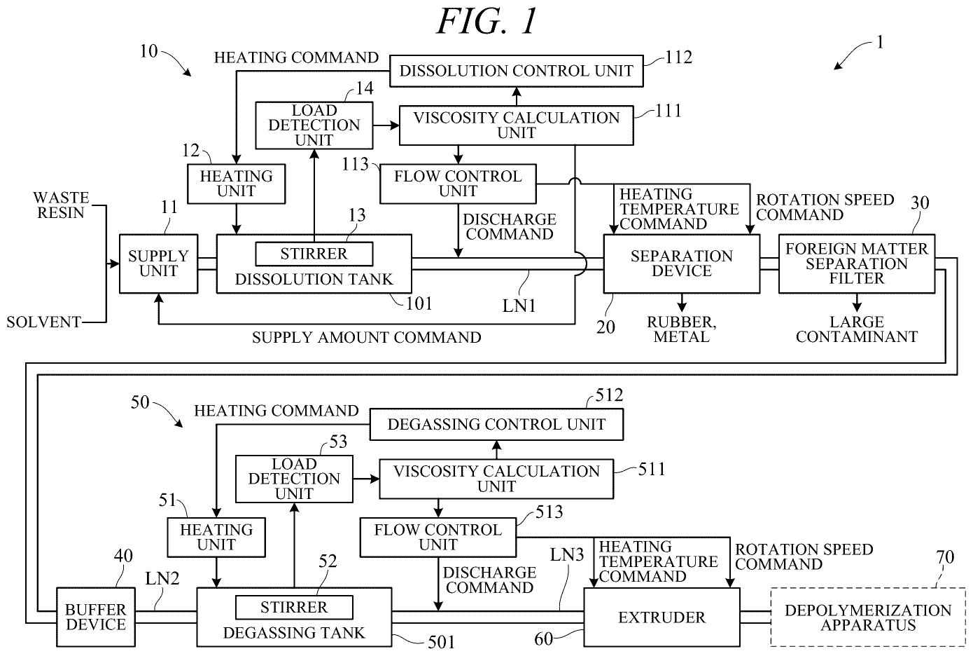

Hereinafter, an embodiment of the present invention will be described with reference to FIGS. 1 to 5. A foreign matter separation system according to the embodiment of the present invention separates foreign matters mixed in waste plastic used for components (interior parts, bumpers, and the like) of a vehicle, more specifically, a synthetic resin blended with glass fibers.

Incidentally, it is assumed that various contaminants (metal, rubber, other resin, and the like) are mixed in waste plastic recovered from the market, and it is necessary to separate these foreign matters before chemical recycling by a depolymerization method or the like. In such foreign matter separation, first, as a pre-process, a so-called dissolution treatment is performed in which waste plastic is dissolved in a solvent to reduce the viscosity. However, it is difficult to predict characteristics (type and amount) of the foreign matters mixed in the recovered material such as the waste plastic, and when the dissolution treatment is performed with operation conditions (solvent input amount and heating temperature) kept constant, there is a possibility that the separation quality in the separation of the foreign matters in a subsequent stage is affected. A method for performing the dissolution treatment by setting operation conditions according to recovered materials for each batch is also conceivable, but in that case, it is not possible to cope with a continuous treatment. Therefore, in order to cope with such a problem, in the present embodiment, a foreign matter separation system is configured as follows.

FIG. 1 is a block diagram illustrating an example of an overall configuration of the foreign matter separation system according to the embodiment of the present invention. As illustrated in FIG. 1, a foreign matter separation system 1 includes a dissolution apparatus 10, a separation device 20, a foreign matter separation filter 30, a buffer device 40, a batch type degassing apparatus 50, and an extruder (hereinafter, referred to as a continuous kneader) 60.

The dissolution apparatus 10 dissolves waste plastic (hereinafter, also referred to as a waste resin), which is a recovered material, in a solvent. The waste resin is polyamide 6 (hereinafter, referred to as PA6GF) blended with glass fibers (hereinafter, referred to as GF). The solvent is ethylene glycol (hereinafter, referred to as EG). Note that the waste resin may be other than PA6GF. In addition, the solvent may be other than EG.

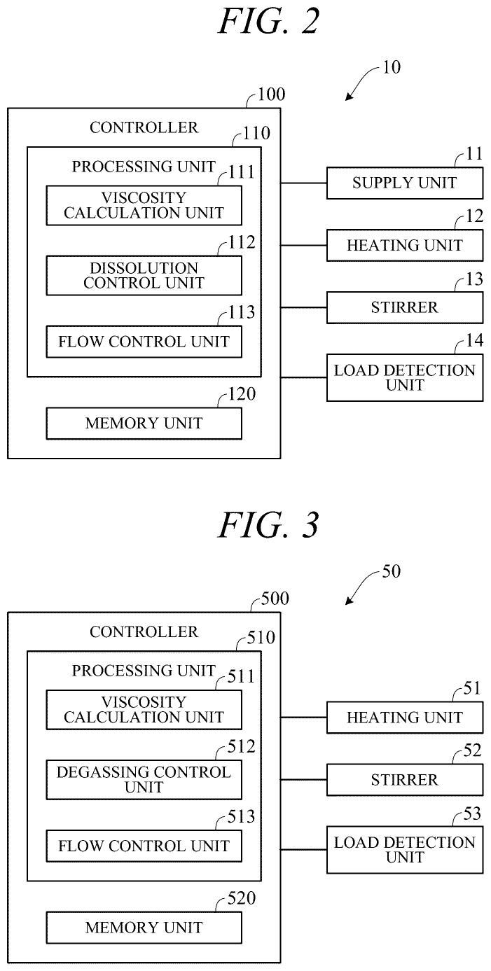

The dissolution apparatus 10 is connected to the separation device 20 via a connection portion LN1, and supplies a solution of the waste resin and the solvent to a separation tank (not illustrated) of the separation device 20 via the connection portion LN1. The connection portion LN1 includes a transport line that connects a dissolution tank 101 of the dissolution apparatus 10 and the separation tank of the separation device 20, and an opening/closing device (opening/closing valve) that is provided in the transport line and is not illustrated. Details of the dissolution apparatus 10 will be described later with reference to FIG. 2.

The separation device 20 is a centrifuge. The separation device 20 has a separation tank (not illustrated) into which the solution supplied from the dissolution apparatus 10 is put, and removes foreign matters (dust, metal, and the like) from the solution in the separation tank by centrifugal separation. The separation device 20 heats the solution in the separation tank such that a temperature of the solution increases to a temperature according to a heating temperature command value to be described later, and centrifugally separates the solution at a rotation speed according to a rotation speed command value to be described later.

The foreign matter separation filter 30 separates a foreign matter (hereinafter, referred to as a large contaminant) having a relatively large size that has not been removed by centrifugal separation from the solution (hereinafter, referred to as a filtrate) from which the foreign matter has been separated in the separation device 20. A filter size of the foreign matter separation filter 30 is, for example, 2 to 5 mm. The buffer device 40 includes a heating device and a stirrer (not illustrated), and temporarily pools the filtrate from which the large contaminant has been removed by the foreign matter separation filter 30. The buffer device 40 pools the filtrate while maintaining the temperature and stirring the filtrate such that the viscosity of the filtrate is maintained at a constant viscosity (for example, 1 Pa·s) or less. The filtrate pooled in the buffer device 40 is supplied to the degassing apparatus 50.

The degassing apparatus 50 is a batch type evaporator. The degassing apparatus 50 is connected to the buffer device 40 via a connection portion LN2. The degassing apparatus 50 includes a degassing tank 501 into which the filtrate supplied from the buffer device 40 via the connection portion LN2 is input. The degassing apparatus 50 evaporates the solvent contained in the filtrate in the degassing tank 501. The connection portion LN2 includes a transport line that connects the buffer device 40 and the degassing tank 501 of the degassing apparatus 50, and an opening/closing device (opening/closing valve) that is provided in the transport line and is not illustrated.

The degassing apparatus 50 is connected to the extruder 60 via a connection portion LN3, and supplies the filtrate in the degassing tank 501 to the extruder 60 via the connection portion LN3. The connection portion LN3 includes a transport line that connects the degassing tank 501 of the degassing apparatus 50 and the extruder 60, and an opening/closing device (opening/closing valve) that is provided in the transport line and is not illustrated. The extruder 60 kneads the filtrate supplied from the degassing apparatus 50 while heating the filtrate, and degasses the solvent remaining without being degassed by the degassing apparatus 50 from the filtrate. The filtrate degassed by the extruder 60 is discharged from the extruder 60 and supplied to a depolymerization apparatus 70 in a subsequent stage. Details of the degassing apparatus 50 will be described later with reference to FIG. 3.

FIG. 2 is a diagram illustrating a configuration of main parts of the dissolution apparatus 10. As illustrated in FIG. 2, the dissolution apparatus 10 includes a controller 100, a supply unit 11, a heating unit 12, a stirrer 13, and a load detection unit 14. The controller 100 includes a computer including a processing unit 110 such as a CPU, a memory unit 120 such as a ROM or a RAM, and other peripheral circuits. Each of the supply unit 11, the heating unit 12, the stirrer 13, and the load detection unit 14 is connected to the controller 100.

The supply unit (supply device) 11 supplies the waste resin and the solvent into the dissolution tank 101. The supply unit 11 includes a solvent inputter (not illustrated) that inputs the solvent into the dissolution tank 101 and a recovered material inputter (not illustrated) that inputs the waste resin into the dissolution tank 101 by a screw transfer method using a screw conveyor or the like. When the supply unit 11 receives a solvent supply command in which the supply amount of the solvent has been designated, the supply unit 11 supplies the solvent to the dissolution tank 101 via the solvent inputter according to the solvent supply command. When the supply unit 11 receives a recovered material amount supply command in which the supply amount of the waste resin has been designated, the supply unit 11 supplies the waste resin to the dissolution tank 101 via the recovered material inputter according to the recovered material amount supply command. The solvent supply command and the recovered material amount supply command will be described later.

When the heating unit (heating device) 12 receives a heating temperature command, the heating unit 12 heats the waste resin and the solvent input into the dissolution tank 101. The heating temperature command will be described later. The stirrer 13 stirs the waste resin heated by the heating unit 12 and the solvent. The load detection unit 14 is a torque sensor, and detects the load torque acting on the stirrer 13.

The controller 100 of FIG. 2 includes a viscosity calculation unit 111, a dissolution control unit 112, and a flow control unit 113 as functional configurations carried by the processing unit 110.

The viscosity calculation unit 111 calculates the viscosity of the solution in the dissolution tank 101, that is, the solution of the waste resin and the solvent, based on the load torque of the stirrer 13 detected by the load detection unit 14.

The dissolution control unit 112 controls at least one of the supply unit 11 and the heating unit 12 such that the viscosity calculated by the viscosity calculation unit 111 becomes less than a predetermined value. Specifically, when the viscosity calculated by the viscosity calculation unit 111 is equal to or more than the predetermined value, the dissolution control unit 112 transmits a heating temperature command to the heating unit 12 such that the temperature of the solution in the dissolution tank 101 increases. When the heating unit 12 receives the heating temperature command, the heating unit 12 starts heating such that the temperature of the solution in the dissolution tank 101 becomes the temperature designated by the heating temperature command. In addition, when the viscosity calculated by the viscosity calculation unit 111 is equal to or more than the predetermined value, the dissolution control unit 112 controls the supply unit 11 so as to increase a supply ratio of the solvent more than a predetermined ratio. More specifically, the dissolution control unit 112 determines an additional supply amount of the solvent such that the viscosity of the solution in the dissolution tank 101 becomes less than a predetermined value. Then, a solvent supply command designating the determined additional supply amount is output to the supply unit 11. As a result, an amount of the solvent corresponding to the additional supply amount is additionally input into the dissolution tank 101 by the supply unit 11. The additional supply amount may be a constant amount or may be determined so as to increase as the viscosity of the solution increases.

The flow control unit 113 controls the flow of the solution stirred in the dissolution tank 101 via the connection portion LN1. Specifically, when the viscosity calculated by the viscosity calculation unit 111 becomes less than the predetermined value, the flow control unit 113 controls the flow of the solution such that the solution in the dissolution tank 101 is supplied to the separation tank of the separation device 20. More specifically, the flow control unit 113 outputs an opening command to the opening/closing valve of the connection portion LN1 to switch the opening/closing valve from a closed state to an opened state. Note that an initial state of the opening/closing valve is the closed state. Further, when the supply of the solution to the separation tank of the separation device 20 is completed, the flow control unit 113 returns the opening/closing valve to the closed state.

Even in a case where the viscosity calculated by the viscosity calculation unit 111 is equal to or more than the predetermined value, the flow control unit 113 outputs an opening command to the opening/closing valve to switch the opening/closing valve from the closed state to the opened state such that the solution in the dissolution tank 101 is supplied to the separation tank of the separation device 20, when a predetermined time elapses from the start of stirring by the stirrer 13. At this time, the flow control unit 113 determines the rotation speed command value and the heating temperature command value based on the viscosity calculated by the viscosity calculation unit 111, and transmits the rotation speed command value and the heating temperature command value to the separation device 20.

The separation device 20 is a centrifuge. The separation device 20 heats the solution supplied from the dissolution tank 101 of the dissolution apparatus 10 such that the temperature of the solution increases to a temperature according to the heating temperature command value, and centrifugally separates the solution at a rotation speed according to the rotation speed command value. Note that the separation device 20 performs heating and centrifugal separation according to the rotation speed and the heating temperature commanded in advance, and when the separation device 20 receives the rotation speed command value and the heating temperature command value from the flow control unit 113, the separation device 20 performs heating and centrifugal separation according to the received command value.

FIG. 3 is a diagram illustrating a configuration of main parts of the degassing apparatus 50. The degassing apparatus 50 includes a controller 500, a heating unit 51, a stirrer 52, and a load detection unit 53. The controller 500 includes a computer including a processing unit 510 such as a CPU, a memory unit 520 such as a ROM or a RAM, and other peripheral circuits. Each of the heating unit 51, the stirrer 52, and the load detection unit 53 is connected to the controller 500.

The heating unit 51 heats the filtrate in the degassing tank 501. The stirrer 52 stirs the filtrate in the degassing tank 501 heated by the heating unit 51. The load detection unit 53 is a torque sensor, and detects the load torque acting on the stirrer 52.

The controller 500 of FIG. 3 includes a viscosity calculation unit 511, a degassing control unit 512, and a flow control unit 513 as functional configurations carried by the processing unit 510.

The viscosity calculation unit 511 calculates the viscosity of the filtrate in the degassing tank 501 based on the load torque of the stirrer 52 detected by the load detection unit 53. The degassing control unit 512 determines the heating temperature of the filtrate in the degassing tank 501 of the degassing apparatus 50 based on the viscosity in the degassing tank 501 calculated by the viscosity calculation unit 511. Specifically, when the viscosity in the degassing tank 501 is less than the prescribed viscosity, the degassing control unit 512 outputs, to the heating unit 51, a heating command designating a heating temperature higher than the current heating temperature.

The flow control unit 513 controls the flow of the filtrate pooled in the buffer device 40 from the buffer device 40 to the degassing apparatus 50 via the connection portion LN2. The connection portion LN2 includes a transport line that connects the buffer device 40 and the degassing tank 501 of the degassing apparatus 50, and an opening/closing device (opening/closing valve) that is provided in the transport line and is not illustrated. When the amount of the filtrate pooled in the buffer device 40 becomes equal to or more than a constant amount, the flow control unit 513 controls the flow of the filtrate such that the filtrate pooled in the buffer device 40 is supplied to the degassing apparatus 50. More specifically, the flow control unit 513 outputs an opening command to the opening/closing valve of the connection portion LN2 to switch the opening/closing valve from the closed state to the opened state. Note that an initial state of the opening/closing valve is the closed state. Further, the flow control unit 513 returns the opening/closing valve to the closed state when the supply of the filtrate to the degassing tank 501 of the degassing apparatus 50 is completed.

Further, the flow control unit 513 controls the flow of the filtrate stirred in the degassing tank 501 from the degassing apparatus 50 to the extruder 60 via the connection portion LN3. Specifically, when the viscosity calculated by the viscosity calculation unit 511 becomes the prescribed viscosity, the flow control unit 513 controls the flow of the filtrate such that the filtrate in the degassing tank 501 is supplied to the extruder 60. More specifically, the flow control unit 513 outputs an opening command to the opening/closing valve of the connection portion LN3 to switch the opening/closing valve from the closed state to the opened state. Even if the viscosity calculated by the viscosity calculation unit 511 is less than the prescribed viscosity, the flow control unit 513 may control the flow of the filtrate such that the filtrate in the degassing tank 501 is supplied to the extruder 60, when a predetermined time elapses from the start of stirring by the stirrer 52. Note that an initial state of the opening/closing valve of the connection portion LN3 is the closed state. When the supply of the filtrate to the extruder 60 is completed, the flow control unit 513 returns the opening/closing valve to the closed state.

When the filtrate in the degassing tank 501 is supplied to the extruder 60, the flow control unit 513 transmits the rotation speed command value and the heating temperature command value to the extruder 60 based on the viscosity calculated by the viscosity calculation unit 511. The extruder 60 heats the filtrate supplied from the degassing tank 501 of the degassing apparatus 50 such that the temperature of the filtrate increases to a temperature according to the heating temperature command value. The extruder 60 rotates a built-in screw (not illustrated) at a rotation speed according to the rotation speed command value to knead the filtrate supplied from the degassing tank 501 of the degassing apparatus 50.

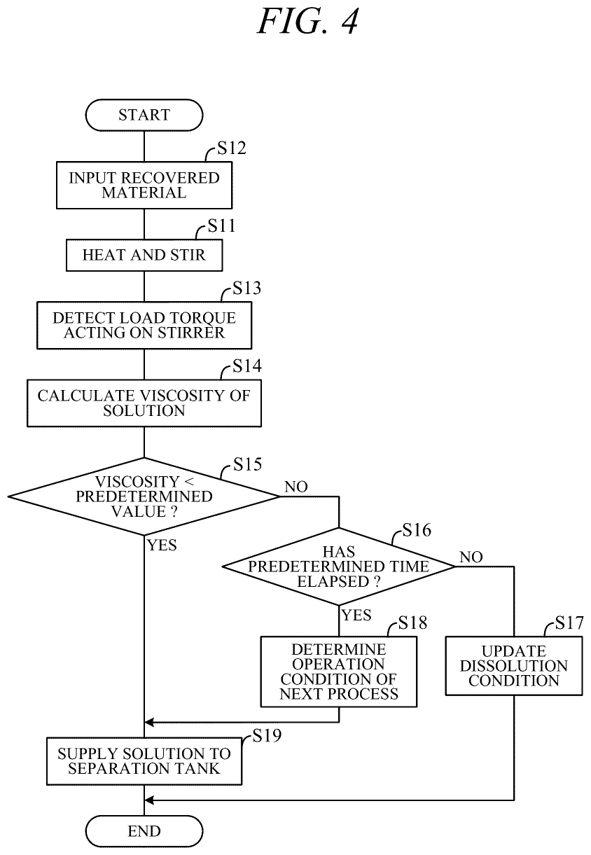

FIG. 4 is a flowchart illustrating an example of processing executed by the controller 100 of the dissolution apparatus 10. The processing illustrated in the flowchart is repeated at a predetermined cycle until step S19 is executed, for example, when a power supply of the dissolution apparatus 10 is turned on.

First, in step S11, a waste resin (powder) is input. More specifically, the controller 100 outputs a solvent supply command designating the supply amount of the solvent to the supply unit 11. In addition, the controller 100 outputs a recovered material amount supply command designating a supply amount of the waste resin to the supply unit 11. At this time, the controller 100 outputs the solvent supply command and the recovered material amount supply command such that a supply ratio of the solvent to the waste resin becomes a predetermined ratio. The supply unit 11 supplies the amount of the solvent designated by the solvent supply command to the dissolution tank 101, and supplies the amount of the waste resin designated by the recovered material amount supply command to the dissolution tank 101.

In step S12, the waste resin and the solvent in the dissolution tank 101 are heated while being stirred. In step S13, the load torque acting on the stirrer 13 via the load detection unit 14 is detected. In step S14, the load torque detected in step S13 is converted into the viscosity of the solution in the dissolution tank 101. Note that this conversion may be performed based on a table or an equation indicating a correlation between the load torque and the viscosity of the solution stored in advance in the memory unit 120 or the like, or may be performed by other methods.

In step S15, it is determined whether or not the viscosity calculated in step S14 is less than a predetermined value. When the determination result is YES in step S15, the process proceeds to step S19. When the determination result is NO in step S15, it is determined in step S16 whether or not a predetermined time has elapsed from the start of stirring by the stirrer 13. When the determination result is NO in step S16, the dissolution conditions are updated in step S17. Specifically, the additional supply amount of the solvent is determined such that the viscosity in the dissolution tank 101 becomes less than a predetermined value. Then, a solvent supply command designating the determined additional supply amount is output to the supply unit 11. As a result, in step S11 of a next cycle, an amount of the solvent corresponding to the additional supply amount is additionally input into the dissolution tank 101. In addition to or instead of the solvent supply command designating the additional supply amount, a heating command may be output to the heating unit 12 such that the temperature of the solution in the dissolution tank 101 increases.

When the determination result is YES in step S16, in step S18, operation conditions of a next process (foreign matter separation process) determined based on the viscosity calculated in step S14 are determined and transmitted to the separation device 20. The operation conditions include a rotation speed command value and a heating temperature command value. In step S19, the flow of the solution is controlled such that the solution in the dissolution tank 101 is supplied to the separation tank of the separation device 20.

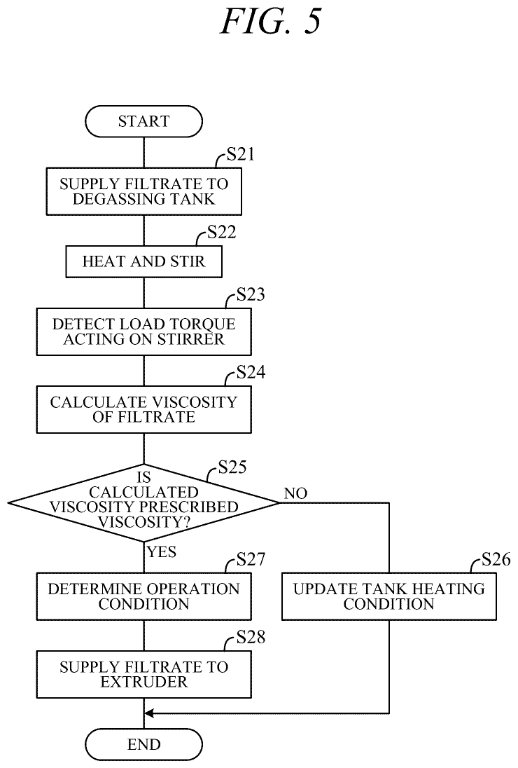

FIG. 5 is a flowchart illustrating an example of processing executed by the controller 500 of the degassing apparatus 50. The processing illustrated in the flowchart is started, for example, when the amount of the filtrate pooled in the buffer device 40 becomes equal to or more than a constant amount, and is repeated at a predetermined cycle until steps S27 and S28 are executed.

First, in step S21, the filtrate pooled in the buffer device 40 is supplied to the degassing tank 501. In step S22, the filtrate in the degassing tank 501 is heated while being stirred. In step S23, the load torque acting on the stirrer 52 via the load detection unit 53 is detected. In step S24, the load torque detected in step S23 is converted into the viscosity of the filtrate in the degassing tank 501. Note that this conversion may be performed based on a table or an equation indicating a correlation between the load torque and the viscosity of the filtrate stored in advance in the memory unit 120 or the like, or may be performed by other methods.

In step S25, it is determined whether or not the viscosity calculated in step S24 is the prescribed viscosity (for example, 10 to 100 Pa·s). When the determination result is NO in step S25, in step S26, heating conditions (hereinafter, referred to as tank heating conditions) of the filtrate are changed such that the filtrate in the degassing tank 501 has the prescribed viscosity. Specifically, when the viscosity of the filtrate in the degassing tank 501 is less than the prescribed viscosity, a heating command designating a heating temperature higher than the current heating temperature is output to the heating unit 51. When the tank heating conditions are updated, the processing ends. As a result, the degassing process by the degassing apparatus 50 is continued according to the updated tank heating conditions.

On the other hand, when the determination result is YES in step S25, in step S27, operation conditions (rotation speed and heating temperature) of the extruder 60 are determined based on the viscosity calculated in step S24, and the rotation speed command value and the heating temperature command value are transmitted to the extruder 60 according to the determined operation conditions. In step S28, the flow of the filtrate is controlled such that the filtrate in the degassing tank 501 is supplied to the extruder 60. As a result, the degassing treatment according to the operation conditions is started in the extruder 60.

According to the present embodiment, the following operations and effects are achievable.

(1) A dissolution apparatus 10 dissolves a waste resin in a dissolution tank 101 with a solvent. The dissolution apparatus 10 includes: a supply unit 11 that supplies the waste resin and the solvent into the dissolution tank 101; a heating unit 12 as a first heating unit that heats the waste resin and the solvent supplied to the dissolution tank 101; a stirrer 13 as a first stirrer that stirs the waste resin and the solvent heated by the heating unit 12; a load detection unit 14 as a first load detection unit that detects a load torque acting on the stirrer 13; a viscosity calculation unit 111 as a first viscosity calculation unit that calculates a viscosity of a solution of the waste resin and the solvent based on the load torque detected by the load detection unit 14; and a dissolution control unit 112 that controls at least one of the supply unit 11 and the heating unit 12 such that the viscosity calculated by the viscosity calculation unit 111 becomes less than a predetermined value. When the viscosity calculated by the viscosity calculation unit 111 is equal to or more than the predetermined value, the dissolution control unit 112 controls the heating unit 12 such that a temperature of the solution increases. In addition, when the viscosity calculated by the viscosity calculation unit 111 is equal to or more than the predetermined value, the dissolution control unit 112 controls the supply unit 11 so as to increase a supply ratio of the solvent more than a predetermined ratio. As described above, in the dissolution process, by performing continuous operation while performing feedback control according to the viscosity of the solution, the solvent addition amount or the heating energy can be optimized without requiring a highly accurate device or the like. In addition, uniformity of the solution supplied to the foreign matter separation process can be secured, and efficient operation can be realized in subsequent processes including the foreign matter separation process.

(2) A foreign matter separation system 1 includes: the dissolution apparatus 10; and a separation device 20 that is connected to the dissolution apparatus 10 via a connection portion LN1 as a first connection portion and separates foreign matters contained in the waste resin from the solution. The dissolution apparatus 10 in the foreign matter separation system 1 further includes a flow control unit 113 as a first flow control unit that controls the flow of the solution stirred in the dissolution tank 101 from the dissolution apparatus 10 to the separation device 20 via the connection portion LN1. When the viscosity calculated by the viscosity calculation unit 111 becomes less than the predetermined value, the flow control unit 113 controls the flow of the solution such that the solution in the dissolution tank 101 is supplied to the separation device 20. More specifically, even if the viscosity calculated by the viscosity calculation unit 111 is equal to or more than the predetermined value, the flow control unit 113 controls the flow of the solution such that the solution in the dissolution tank 101 is supplied to the separation device 20, when a predetermined time elapses from the start of stirring by the stirrer 13. Further, the flow control unit 113 transmits a rotation speed command value and a heating temperature command value determined based on the viscosity calculated by the viscosity calculation unit 111 to the separation device 20. As a result, the quality of the foreign matter separation process can be further stabilized.

(3) The foreign matter separation system 1 further includes a degassing apparatus 50 as a first degassing apparatus and an extruder 60 as a second degassing apparatus, which degas the solvent contained in the solution from which the foreign matters have been separated by the separation device 20. The extruder 60 is connected to the degassing apparatus 50 via a connection portion LN2 as a second connection portion. The degassing apparatus 50 includes: a degassing tank 501 to which the solution from which the foreign matters have been separated is supplied from the separation device 20; a heating unit 51 as a second heating unit that heats the solution supplied into the degassing tank 501; a stirrer 52 as a second stirrer that stirs the solution heated by the heating unit 51; a load detection unit 53 as a second load detection unit that detects a load torque acting on the stirrer 52; a viscosity calculation unit 511 as a second viscosity calculation unit that calculates the viscosity of the solution in the degassing tank 501 based on the load torque acting on the stirrer 52 detected by the load detection unit 53; and a flow control unit 513 as a second flow control unit that controls the flow of the solution stirred in the degassing tank 501 from the degassing apparatus 50 to the extruder 60 via the connection portion LN2. When the viscosity calculated by the viscosity calculation unit 511 becomes less than the prescribed viscosity, the flow control unit 513 controls the flow of the solution such that the solution in the degassing tank 501 is supplied to the extruder 60, and transmits the rotation speed command value and the heating temperature command value determined based on the viscosity calculated by the viscosity calculation unit 511 to the extruder 60. The extruder 60 is an extruder that extrudes the solution supplied from the degassing apparatus 50 while rotating a built-in screw. The extruder 60 heats the solution supplied from the degassing apparatus 50 such that a temperature of the solution becomes a temperature according to the heating temperature command value, and rotates the screw at a rotation speed according to the rotation speed command value. By such two-stage degassing treatment, the contaminants can be appropriately removed regardless of the state of the recovered material (amount of foreign matters mixed).

The above embodiment can be modified into various forms. Modifications are described below.

In the above embodiment, the dissolution apparatus 10 including the single controller 100 has been taken as an example (FIG. 2). However, the dissolution apparatus 10 may include a plurality of distributed controllers. In addition, in the above embodiment, the degassing apparatus 50 including the single controller 500 has been taken as an example (FIG. 3). However, similarly, the degassing apparatus 50 may include a plurality of distributed controllers.

The above embodiment can be combined as desired with one or more of the above modifications. The modifications can also be combined with one another.

According to the present invention, the efficient operation can be realized in the foreign matter separation process.

Above, while the present invention has been described with reference to the preferred embodiments thereof, it will be understood, by those skilled in the art, that various changes and modifications may be made thereto without departing from the scope of the appended claims.

What is claimed is:

1. A dissolution apparatus configured to dissolve a waste resin in a dissolution tank with a solvent, the dissolution apparatus comprising:
a supply device configured to supply the waste resin and the solvent into the dissolution tank;
a heating device configured to heat the waste resin and the solvent supplied to the dissolution tank;
a stirrer configured to stir the waste resin and the solvent, heated by the heating device;
a torque sensor configured to detect a load torque acting on the stirrer; and
a microprocessor, wherein
the microprocessor is configured to perform:
calculating a viscosity of a solution of the waste resin and the solvent based on the load torque detected by the torque sensor, and
controlling at least one of the supply device and the heating device such that the viscosity calculated in the calculating becomes less than a predetermined value.

2. The dissolution apparatus according to claim 1, wherein
the microprocessor is configured to perform:
the controlling including, when the viscosity calculated in the calculating is equal to or more than the predetermined value, controlling the heating device such that a temperature of the solution increases.

3. The dissolution apparatus according to claim 1, wherein
the microprocessor is configured to perform:
the controlling including, when the viscosity calculated in the calculating is equal to or more than the predetermined value, controlling the supply device so as to increase a supply ratio of the solvent more than a predetermined ratio.

4. A foreign matter separation system comprising: the dissolution apparatus according to claim 1, and a separation device connected to the dissolution apparatus via a connection portion and separating a foreign matter contained in the waste resin from the solution,
the microprocessor is configured to perform:
controlling a flow of the solution stirred in the dissolution tank from the dissolution apparatus to the separation device via the connection portion, the controlling of the flow of the solution including, when the viscosity calculated in the calculating becomes less than the predetermined value, controlling the flow of the solution such that the solution in the dissolution tank is supplied to the separation device.

5. The foreign matter separation system according to claim 4, wherein
the microprocessor is configured to perform the controlling of the flow of the solution including, even if the viscosity calculated in the calculating is equal to or more than the predetermined value, controlling the flow of the solution such that the solution in the dissolution tank is supplied to the separation device when a predetermined time elapses from a start of stirring by the stirrer, and transmitting a rotation speed command value and a heating temperature command value determined based on the viscosity calculated in the calculating to the separation device, and
in the separation device, the solution supplied from the dissolution apparatus is heated so as to increase to a temperature according to the heating temperature command value, and is centrifugally separated by a rotation speed according to the rotation speed command value.

6. The foreign matter separation system according to claim 5, wherein
the heating device is a first heating device, the stirrer is a first stirrer, the torque sensor is a first torque sensor, and the connection portion is a first connection portion,
the foreign matter separation system further comprising a first degassing apparatus and a second degassing apparatus, configured to degas the solvent contained in the solution from which the foreign matter has been separated by the separation device,
the second degassing apparatus is connected to the first degassing apparatus via a second connection portion,
the microprocessor is a first microprocessor,
the first degassing apparatus comprises:
a second microprocessor;
a degassing tank supplied with the solution from which the foreign matter has been separated, from the separation device;
a second heating device configured to heat the solution supplied into the degassing tank;
a second stirrer configured to stir the solution heated by the second heating device; and
a second torque sensor configured to detect a load torque acting on the second stirrer, wherein
the second microprocessor is configured to perform:
calculating a viscosity of the solution in the degassing tank based on the load torque acting on the second stirrer detected by the second torque sensor; and
controlling a flow from the first degassing apparatus to the second degassing apparatus via the second connection portion, of the solution stirred in the degassing tank, and wherein
the second microprocessor is configured to perform the controlling of the flow of the solution stirred in the degassing tank including, when the viscosity in the degassing tank calculated in the calculating becomes a prescribed viscosity, controlling the flow of the solution such that the solution in the degassing tank is supplied to the second degassing apparatus, and transmitting a second rotation speed command value and a second heating temperature command value determined based on the viscosity in the degassing tank calculated in the calculating to the second degassing apparatus, and
in the second degassing apparatus, the solution supplied from the first degassing apparatus is heated so as to increase to a temperature according to the second heating temperature command value and is discharged while rotating a screw at a rotation speed according to the second rotation speed command value.

7. The foreign matter separation system according to claim 6, wherein
the second microprocessor is configured to perform the controlling of the flow of the solution stirred in the degassing tank including, even if the viscosity in the degassing tank calculated in the calculating is less than the prescribed viscosity, controlling the flow of the solution such that the solution in the degassing tank is supplied to the second degassing apparatus when a predetermined time elapses from a start of stirring by the second stirrer,, and transmitting the second rotation speed command value and the second heating temperature command value to the second degassing apparatus.

8. The foreign matter separation system according to claim 6, wherein
the first degassing apparatus is a batch type evaporator, and
the second degassing apparatus is an extruder.

9. A dissolution method of a dissolution apparatus configured to dissolve a waste resin in a dissolution tank with a solvent, the dissolution apparatus comprising: a supply device configured to supply the waste resin and the solvent into the dissolution tank; a heating device configured to heat the waste resin and the solvent supplied to the dissolution tank; a stirrer configured to stir the waste resin and the solvent heated by the heating device; and a torque sensor configured to detect a load torque acting on the stirrer, and the dissolution method comprising:
calculating a viscosity of a solution of the waste resin and the solvent based on the load torque detected by the torque sensor, and
controlling at least one of the supply device and the heating device such that the viscosity calculated in the calculating becomes less than a predetermined value.
